(19) United States
(12) Patent Application Publication
(10) Pub. No.: US 2011/0081967 A1
(43) Pub. Date: Apr. 7, 2011

(54) INTERACTIVE MEDIA SOCIAL GAME

(75) Inventors: Thomas C. Butcher, Seattle, WA (US); Sahil Thaker, Issaquah, WA (US); Christopher B. Weare, Bellevue, WA (US)

(73) Assignee: MICROSOFT CORPORATION, Redmond, WA (US)

(21) Appl. No.: 12/573,571

(22) Filed: Oct. 5, 2009

(51) Int. Cl. A63F 13/00; G06N 5/02; G06Q 30/00; G06Q 50/00; A63F 9/24; G06F 3/01

(52) U.S. Cl. 463/35; 706/46; 705/14.12; 463/42; 715/752

(57) ABSTRACT

An interactive media social game is described. In embodiments, a social game service administrates a networked social game based on media asset interactions. Media asset interaction data is received that identifies media assets when they are downloaded or played at a user device. The media assets are correlated with a social game entity, such as a music pet that is a token entity of the networked social game. The music pet adaptively changes according to characteristics of the media assets. The media asset interaction data is also compiled as a media asset selection history corresponding to a user that is associated with the user device. A media asset recommendation for the user can be generated based on the media asset selection history, and the media asset recommendation is communicated as a recommendation message from the music pet to the user that is associated with the user device.

### BACKGROUND

Users interact with media assets, such as to play music or watch a video on a portable media player. However, media asset usage on a user device is often times a passive process. Once a user downloads and saves a music library at the user device, there is little interaction with a music service that initially provides the music for the library. The user can simply playback any of the songs in the music library when convenient for the user. Thus, it is difficult to keep users interested in a music service that also provides recommendations based on the music that a user downloads. A recommendation system relies on user input to progressively update and determine new recommendations. Further, users that are active on social networking sites may find that a site lacks interesting interaction to keep the users engaged in social networking.

### SUMMARY

This summary is provided to introduce simplified concepts of an interactive media social game. The simplified concepts are further described below in the Detailed Description. This summary is not intended to identify essential features of the claimed subject matter, nor is it intended for use in determining the scope of the claimed subject matter.

An interactive media social game is described. In embodiments, a social game service administrates a networked social game based on media asset interactions. Media asset interaction data is received that identifies media assets, such as musical performances, when they are downloaded or played at a user device. The media assets are correlated with a social game entity, such as a music pet that is a token entity of the networked social game. The music pet adaptively changes according to characteristics of the media assets. For example, the music pet can adaptively change behaviors, appearance, or attributes that reflect the characteristics of the musical performances. The media asset interaction data is also compiled as a media asset selection history corresponding to a user that is associated with the user device. A media asset recommendation for the user can be generated based on the media asset selection history, and the media asset recommendation is communicated as a recommendation message from the music pet to the user that is associated with the user device.

In other embodiments, a status of a social game entity, such as the music pet, can be communicated to the user that is associated with the social game entity and the user device. The status of the music pet can be communicated to the user via the user device as any one of a text message, an email, a data feed, or a message displayed on a user interface. A social game reward can be provided for the user where the reward is based on the adaptive changes to the music pet that are derived from the media assets. Alternatively or in addition, a status ranking of the user can be established based on a culmination of the adaptive changes to the music pet.

In other embodiments, the music pet represents the user that is associated with the user device. The user can be represented in a social group of participants in the networked social game. The music pet can also represent a personality of the user as a user profile in the social group. The music pet, or other social game entity, can be displayed to represent the user profile on a social network user interface, or on a user interface for the social game. The music pet can be displayed as any one or combination of an animation, an image, a graphic, or text.

### BRIEF DESCRIPTION OF THE DRAWINGS

Embodiments of an interactive media social game are described with reference to the following drawings. The same numbers are used throughout the drawings to reference like features and components:

FIG. 1 illustrates an example system in which embodiments of an interactive media social game can be implemented.

FIG. 2 illustrates an example system in which embodiments of an interactive media social game can be implemented.

FIG. 3 illustrates example method(s) for an interactive media social game in accordance with one or more embodiments.

FIG. 4 illustrates various components of an example device that can implement embodiments of an interactive media social game.

### DETAILED DESCRIPTION

Embodiments of an interactive media social game provide a media interaction and entertainment experience that encourages users to participate in a networked social game to receive the benefits of social interaction and recommendations for media assets, such as music and movies. A symbiotic relationship is established between a user of a user device and a social game entity, such as a music pet, that adaptively changes and develops based on characteristics of media assets that a user interacts with via a user device. For example, the media assets may be musical performances, and the characteristics of the media assets include a genre of the musical performances that the music pet adaptively changes to portray. A music pet can adaptively change any one of behaviors, appearance, or attributes that reflect the characteristics of the musical performances. For example, a social game service that administrates the social game and manages the social game entities can be implemented to generate a new list of behaviors and/or appearance of a music pet after a set number of media assets are downloaded or played at a user device that is associated with a user and the music pet.

While features and concepts of the described systems and methods for interactive media social game can be implemented in any number of different environments, systems, and/or various configurations, embodiments of interactive media social game are described in the context of the following example systems and environments.

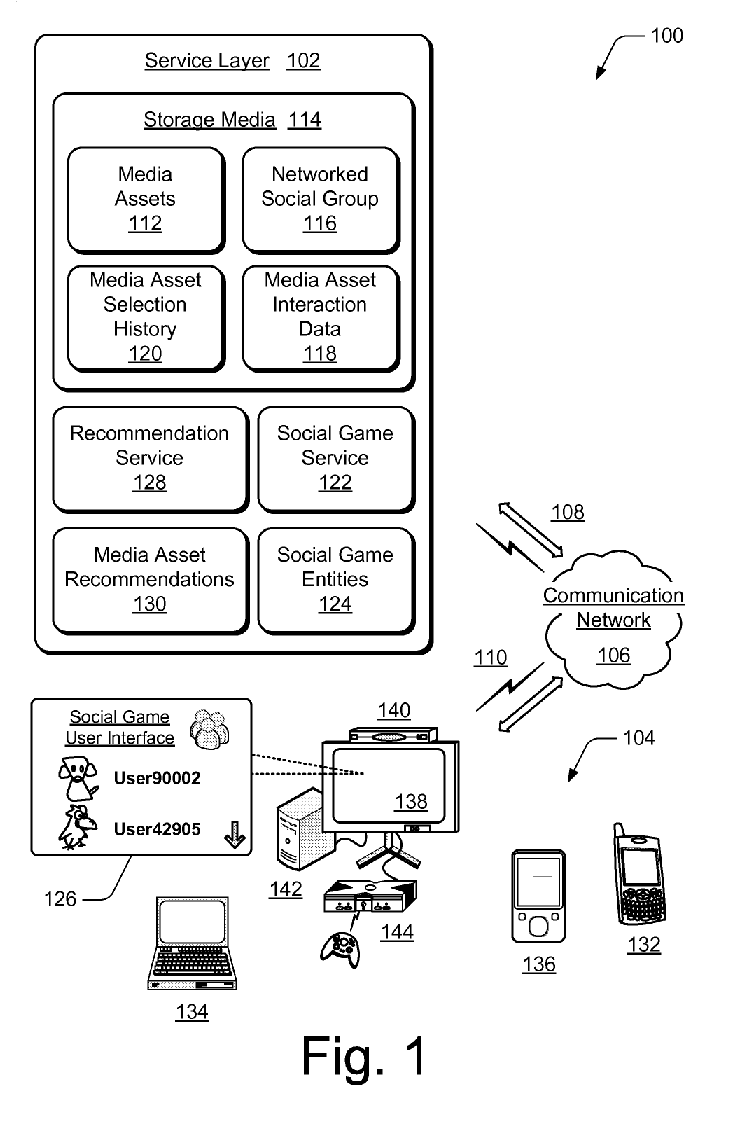

FIG. 1 illustrates an example system 100 in which various embodiments of an interactive media social game can be implemented. In this example, system 100 includes a service layer 102 that can be configured to communicate or otherwise provide media assets and data to any number of various user devices 104 via a communication network 106. Some of the user devices 104 may also be referred to as portable devices and/or client devices. The user devices 104 can include wired and/or wireless devices, some of which may be implemented as components in a client system of a media asset distribution system.

The communication network 106 can be implemented to include a broadcast network, an IP-based network 108, and/or a wireless network 110 that facilitates media asset distribution and data communication between the service layer 102 and any number of the various devices. The communication network 106 can also be implemented as part of a media asset distribution system using any type of network topology and/or communication protocol, and can be represented or otherwise implemented as a combination of two or more networks.

Service layer 102 can include one or more media content servers that are implemented to communicate, or otherwise distribute, the media assets 112 and/or other data to any number of the various user devices. In this example system 100, service layer 102 includes storage media 114 to store or otherwise maintain various data and media assets, such as media assets 112, data pertaining to users in a networked social group 116, media asset interaction data 118, and a media asset selection history 120 for each of the users in the networked social group 116. The storage media 114 can be implemented as any type of memory, random access memory (RAM), a nonvolatile memory such as flash memory, read only memory (ROM), and/or other suitable electronic data storage.

The media assets 112 can include any type of audio, video, and/or image data received from any type of media content or data source. As described throughout, media assets can include music (e.g., digital music files of songs), television programming, movies, on-demand media assets, interactive games, network-based applications, and any other audio, video, and/or image data (e.g., to include program guide data, user interface data, advertising content, closed captions data, content metadata, search results and/or recommendations, etc.).

The media asset interaction data 118 corresponds to a media asset and identifies the media asset when downloaded and/or recently played at any of the various user devices 104. The media asset interaction data 118 correlates to a media asset, or media assets, that have been selected by a user and/or user interactions with the selected media assets via any of the various user devices. A user device 104 can communicate the media asset interaction data 118 to the service layer 102 when the media asset is downloaded, played, and/or rendered at the user device. Alternatively or in addition, the service layer 102 can poll the various user devices to request the media asset interaction data.

In various embodiments, the media asset interaction data 118 can correspond to a single media asset that is recently played at one or more of the various user devices 104. Alternatively or in addition, the media asset interaction data 118 can correspond to a collection of media assets that are associated with a performer, such as an artist, a singer, an actor or actress, or any other performer. Alternatively or in addition, the media asset interaction data 118 can correspond to a genre of media assets, where a genre describes the media assets, such as music content or video content. A genre of video content may be described as being an advertisement, a movie, a comedy show, a sporting event, a news program, a sitcom, a talk show, an action/adventure program, or as any number of other category descriptions. A genre of music content may be described as country-western, blues, jazz, rock, instrumental, acoustic, easy-listening, or as any number of other category descriptions.

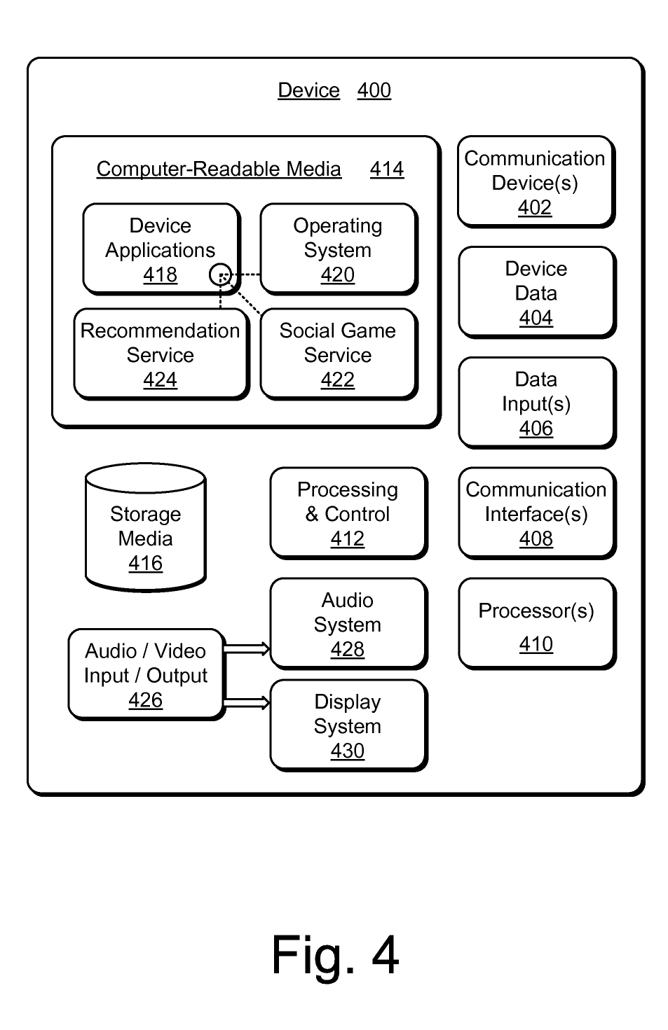

The service layer 102 includes a social game service 122 that can be implemented as computer-executable instructions and executed by processors to implement the various embodiments and/or features described herein. In addition, the service layer 102 can be implemented with any number and combination of differing components as further described with reference to the example device shown in FIG. 4. The social game service 122, as well as other functionality described to implement embodiments of an interactive media social game, can also be provided as a service apart from the service layer 102 (e.g., on a separate server or by a third party service).

The social game service 122 is implemented to administrate a networked social game based on media asset interactions at the various user devices 104. The social game is a media entertainment experience that encourages users to interact with a social group, and in an embodiment, the media entertainment experience is a networked social game that involves interaction with music pets that are token entities of the game. A user can join the game by initiating the selection of a social game entity 124, such as a music pet, and by selecting or establishing parameters and/or characteristics of the social game entity. Initially, a user can select a class of music pet to acquire. Alternatively, the social game service 122 can automatically initialize a social game entity 124 for a user.

A music pet (e.g., a social game entity 124) is a virtual entity that is controlled or managed by the social game service 122. Music pets can be depicted or represented in different ways that provide an indication as to parameters of the social game. For example, a music pet may be a small dog while another music pet might be a giant sea turtle. The small dog would need to be fed more often than the turtle, however the turtle would likely live longer than the small dog. A user can interact with a music pet and the social game via a user interface 126 that can be displayed at any of the various user devices 104 (e.g., the wired and/or wireless devices). A user can name a music pet and control other parameters of the social game entity via the user interface 126, which may also include various dialogue boxes and user-selectable controls. In this example, the user interface 126 depicts two users of the networked social group 116, and each user is represented by a music pet (i.e., a dog for one and a bird for the other). In an implementation, a music pet may begin as a simple single-cell organism that grows, changes, or otherwise morphs into a music pet as the social game entity develops to reflect music selections and/or other media asset interactions by the user at a user device.

The social game service 122 can receive the media asset interaction data 118 that identifies media assets 112 when downloaded, played, or otherwise rendered at a user device 104. The social game service 122 can then correlate the media assets with a music pet that is a token entity of the networked social game. A music pet can represent a user or user profile in the networked social group 116 of participants in the social game, and/or represent a personality of a user in the social game or in the networked social group. Additionally, a music pet may be included as a friend or independent personality in a list of friends that is associated with the user. A music pet can be displayed, such as on the user interface 126, as any one or combination of an animation, an image, a graphic, or text.

The music pet adaptively changes according to characteristics of the media assets. For example, the media assets may be musical performances, such as digital music files of songs that are performed as instrumentals; songs sung by performers, groups, or bands with or without instruments; videos of the songs being performed; or any other type of musical performance. The characteristics of the media assets include a genre of the musical performances and the music pet can adaptively change to portray the genre. The social game service 122 can determine the characteristics of the media assets based on the media asset selection history 120. In embodiments, the music pet can adaptively change any one of behaviors, appearance, or attributes that reflect the characteristics of the musical performances. For example, the social game service 122 that administrates the social game and manages the social game entities may be implemented to generate a new list of behaviors and/or appearance of a music pet after a set number of media assets are downloaded or played at a user device that is associated with a user and the music pet.

The service layer 102 also includes a recommendation service 128 that can be implemented as computer-executable instructions and executed by processors to implement the various embodiments and/or features described herein. The recommendation service 128 can compile the media asset selection history 120 from the media asset interaction data 118 when received from a user device that corresponds to a user. The recommendation service 128 can then generate a media asset recommendation 130 for the user based on the media asset selection history 120. The media asset recommendation 130 can also be communicated to the user via a user device as a recommendation message from the music pet to the user that is associated with the user device. The recommendation message can be communicated to the user as any one of a text message, an email, a data feed, or a message displayed on a user interface 126.

As a user selects media assets at a user device 104 to download and/or playback, a music pet that is associated with the user is fed by the media interaction. As with a real pet animal, the music pet needs to be fed a sufficient diet at regular intervals to sustain participation in the social game, or the game ends when the pet dies. A user can be encouraged to continue as a game participant when messages are communicated to the user, such as event messages that indicate a hungry music pet needs to be fed (i.e., by user interactions with the media assets). During protracted intervals without user input or media asset interaction, the social game service 122 can initiate a message to the user via an associated user device to request user attention directly. When the music pet is fed by the media asset interactions, the music pet doesn't need as much attention. Any other similarities with real pet animals can be implemented in the social game for a music pet and managed by the social game service.

A music pet can adaptively change any one of behaviors, appearance, or attributes that reflect the characteristics of the media assets, and the changes can be based on metadata of a song, such as the genre, recording artist, date released, how popular the song is, and any other characteristics. For example, one user may listen mostly to heavy metal music, and the music pet that is associated with the user may develop a behavior over time that evinces the diet of heavy metal music, such as exhibiting dark facial hair, tattoos, and so forth. Another user may listen to a variety of different types of music, and the music pet that is associated with the user may exhibit a casual dress style based on the diet of music variety. Another user may often listen to Latin dance music and the music pet that is associated with the user may be animated and appear to Tango when displayed on the user interface 126 at any of the various user devices 104. It should be noted that a single user may have several music pets at any one time, and may direct which music pets are associated with different media asset interactions. For example, a user may have both a blues hippo that reflects user interactions with blues music and performances, and also a hip-hop dog that reflects user interactions with various types of rap music and performances.

In an embodiment, the social game service 122 can facilitate competitions between various social game entities 124 that are associated with the same or different users. For example, two music pets could be selected to face-off against each other, and based on their health and other properties, along with other parameters and a degree of randomness, one music pet can win the face off. In another example, two different users may be associated with social game entities 124 that are game cars. Similar to a music pet, a game car can adaptively change according to characteristics of the media assets that a user interacts with at a user device. A user may start initially with a junker or beater car that evolves into a high-performance vehicle as the quantity of user interactions with the media assets increases. Two of the game cars can then be selected to face-off against each other, such as in a race for pink slips. The social game service 122 can generate a reward, such as free music downloads or a free month of service, for the user that is associated with a winning music pet or game car, or other type of social game entity. The social game service 122 can also establish a status ranking of the user based on a reward system and/or a culmination of the adaptive changes to a social game entity.

In this example system 100, wireless devices can include any type of device implemented to receive and/or communicate wireless data, such as any one or combination of a mobile phone 132 (e.g., cellular, VoIP, WiFi, etc.), a portable computer device 134, a media device 136 (e.g., a personal media player, portable media player, etc.), and/or any other wireless device that can receive media assets in any form of audio, video, and/or image data. A client system can include a respective client device and display device 138 that together render or playback any form of audio, video, and/or image media content and media assets.

The display device 138 can be implemented as any type of a television, high definition television (HDTV), LCD, or similar display system. A client device can be implemented as any one or combination of a television client device 140 (e.g., a television set-top box, a digital video recorder (DVR), etc.), a computer device 142, a gaming system 144, an appliance device, an electronic device, and/or as any other type of client device or user device that may be implemented to receive media assets in any form of audio, video, and/or image data in a media asset distribution system.

Any of the various user devices 104 can be implemented with one or more processors, communication components, memory components, signal processing and control circuits, and a media asset rendering system. Further, any of the wireless devices and/or other client devices can be implemented with any number and combination of differing components as further described with reference to the example device shown in FIG. 4. A user device may also be associated with a user (i.e., a person) and/or an entity that operates the device such that a user device describes logical devices that include users, software, and/or a combination of devices.

Any of the user devices 104 can communicate with service layer 102 via a two-way data communication link of the communication network 106. It is contemplated that any one or more of the arrowed communication links, along with communication network 106, facilitate two-way data communication, such as from a user device 104 to the service layer 102 and vice-versa.

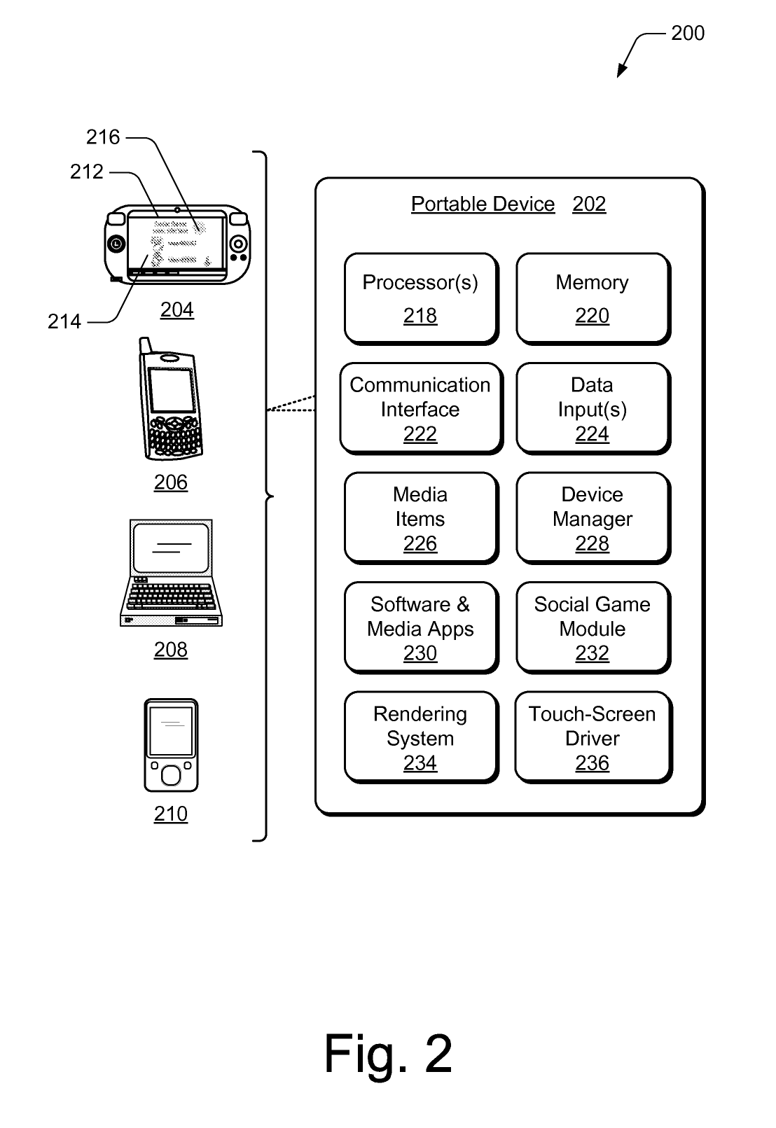

FIG. 2 illustrates an example system 200 in which various embodiments of an interactive media social game can be implemented. Example system 200 includes a portable device 202 (e.g., a wired and/or wireless device) that can be any one or combination of a mobile personal computer 204, a personal digital assistant (PDA), a mobile phone 206 (e.g., cellular, VoIP, WiFi, etc.) that is implemented for data, messaging, and/or voice communications, a portable computer device 208 (e.g., a laptop computer, a laptop computer with a touch-screen, etc.), a media device 210 (e.g., a personal media player, portable media player, etc.), a gaming device, an appliance device, an electronic device, and/or any other type of portable device that can receive, display, and/or communicate data in any form of audio, video, and/or image data.

Each of the various portable devices can include an integrated display and/or an integrated touch-screen, as well as selectable input controls via which a user can input data and/or selections. For example, mobile personal computer 204 includes an integrated touch-screen 212 on which a user interface 214 can be displayed that includes displayable objects and/or user interface elements 216, such as any type of an icon, image, graphic, text, selectable button, user-selectable control, menu selection, map element, and/or any other type of user interface displayable feature or item.

Any of the various portable devices described herein can be implemented with one or more sensors, processors, communication components, data inputs, memory components, storage media, processing and control circuits, and/or a content rendering system. Any of the portable devices can also be implemented for communication via communication networks that can include any type of a data network, voice network, broadcast network, an IP-based network, and/or a wireless network that facilitates data, messaging, and/or voice communications. A portable device can also be implemented with any number and combination of differing components as described with reference to the example device shown in FIG. 4. A portable device may also be associated with a user (i.e., a person) and/or an entity that operates the device such that a portable device describes logical devices that include users, software, and/or a combination of devices.

In this example, portable device 202 includes one or more processors 218 (e.g., any of microprocessors, controllers, and the like), a memory 220, a communication interface 222 for data, messaging, and/or voice communications, and data inputs 224 to receive media items 226 and/or media content. Media items can include any type of email messages, text messages, digital photos, song selections, and the like. Media content (e.g., to include recorded media content) can include any type of audio, video, and/or image data received from any media content or data source, such as messages, television media content, music, video clips, data feeds, interactive games, network-based applications, and any other content. Portable device 202 is implemented with a device manager 228 that includes any one or combination of a control application, software application, signal processing and control module, code that is native to the particular device, and/or a hardware abstraction layer for the particular device.

Portable device 202 includes various software and/or media applications 230 that may incorporate components and/or modules that can be processed or otherwise executed by the processors 218. The media applications 230 can include a music and/or video player, a Web browser, an email application, a messaging application, a photo viewer, and the like. The software and/or media applications 230 can also include an operating system and a social game module 232 to implement various embodiments of an interactive media social game on user device as described herein.

Portable device 202 includes a rendering system 234 to render user interfaces and user interface elements for display on any of the portable devices. The rendering system 234 is also implemented to receive and render any form of audio, video, and/or image data received from any media content and/or data source. Portable device 202 may also include a touch-screen driver 236 to detect touch inputs to a touch-screen that is integrated with the portable device 202.

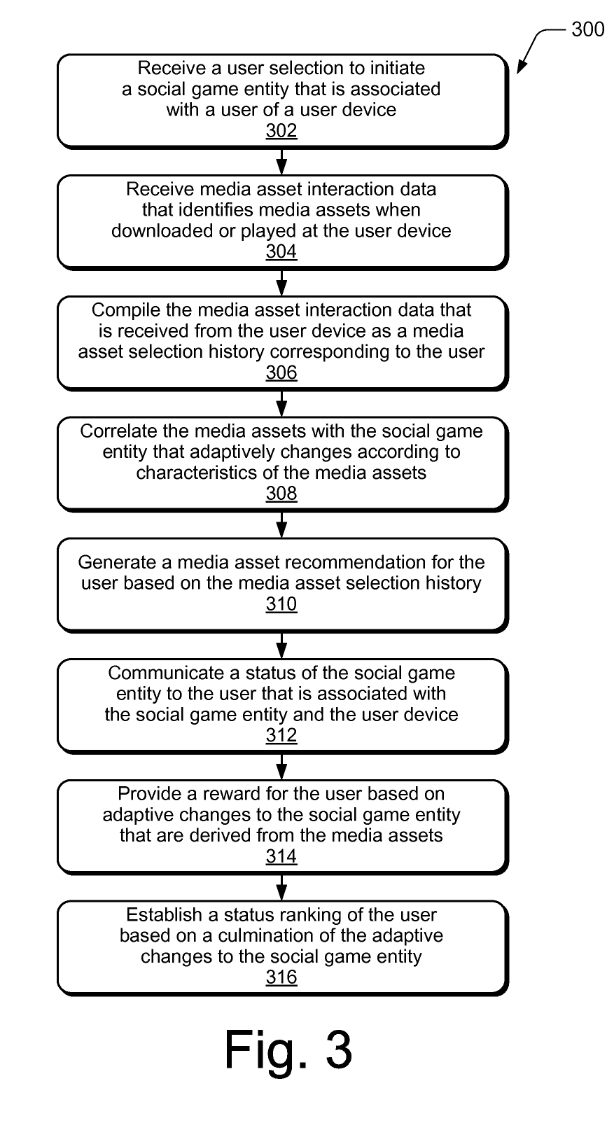

Example method 300 is described with reference to FIG. 3 in accordance with one or more embodiments of an interactive media social game. Generally, any of the functions, methods, procedures, components, and modules described herein can be implemented using hardware, software, firmware, fixed logic circuitry, manual processing, or any combination thereof A software implementation represents program code that performs specified tasks when executed by a computer processor. The example methods may be described in the general context of computer-executable instructions, which can include software, applications, routines, programs, objects, components, data structures, procedures, modules, functions, and the like. The methods may also be practiced in a distributed computing environment by processing devices that are linked through a communication network. In a distributed computing environment, computer-executable instructions may be located in both local and remote computer storage media and/or devices. Further, the features described herein are platform-independent and can be implemented on a variety of computing platforms having a variety of processors.

FIG. 3 illustrates example method(s) 300 of interactive media social game. The order in which the method is described is not intended to be construed as a limitation, and any number of the described method blocks can be combined in any order to implement the method, or an alternate method.

At block 302, a user selection is received to initiate a social game entity that is associated with a user of a user device. For example, the social game service 122 receives a user selection via one of the user devices 104 to initiate a social game entity 124, such as a music pet or other token entity for the social game. The music pet adaptively changes according to characteristics of media assets, such as musical performances. The characteristics include a genre that is associated with the musical performances, and the music pet adaptively changes to portray the genre.

The music pet adaptively changes any one or combination of behaviors, appearance, or attributes that reflect the characteristics of the musical performances. Additionally, the music pet represents the user in the networked social group 116 and/or in a social group of participants of the networked social game. The music pet can also represent a personality of the user as a user profile in the social group. The music pet, or other social game entity, can be displayed to represent the user profile on a social network user interface, or on a user interface 126 for the social game. The music pet can be displayed as any one or combination of an animation, an image, a graphic, or text.

At block 304, media asset interaction data is received that identifies media assets when downloaded or played at the user device. For example, the social game service 122 receives the media asset interaction data 118 that identifies media assets 112 when downloaded, played, or otherwise rendered at a user device 104. At block 306, the media asset interaction data that is received from the user device is compiled as a media asset selection history corresponding to the user. For example, the recommendation service 128 compiles the media asset selection history 120 from the media asset interaction data 118 when received from a user device that corresponds to a user. At block 308, the media assets are correlated with the social game entity that adaptively changes according to characteristics of the media assets. For example, the social game service 122 correlates the media assets with a music pet that is a token entity of the networked social game.

At block 310, a media asset recommendation is generated for the user based on the media asset selection history. For example, the recommendation service 128 generates a media asset recommendation 130 for the user based on the media asset selection history 120. The media asset recommendation 130 can also be communicated to the user via a user device as a recommendation message from the music pet to the user that is associated with the user device. The recommendation message can be communicated to the user as any one of a text message, an email, a data feed, or a message displayed on a user interface 126.

At block 312, a status of the social game entity is communicated to the user that is associated with the social game entity and the user device. For example, the social game service 122 generates and communicates a status of the social game entity to the user via a user device 104 as any one or combination of a text message, an email, a data feed, or a message displayed on a user interface 126 of the social game.

At block 314, a reward is provided for the user based on adaptive changes to the social game entity that are derived from the media assets. For example, the social game service 122 generates a reward, such as free music downloads or a free month of service, based on adaptive changes to a social game entity and/or based on a winning music pet or game car, or other type of social game entity, in a match-up or face-off of social game entities. At block 316, a status ranking of the user is established based on a culmination of the adaptive changes to the social game entity. For example, the social game service 122 establishes a status ranking of the user based on a reward system and/or a culmination of the adaptive changes to a social game entity.

FIG. 4 illustrates various components of an example device 400 that can be implemented as any type of device and/or service layer as described with reference to FIGS. 1 and 2 to implement embodiments of an interactive media social game. In embodiments, device 400 can be implemented as any one or combination of a wired and/or wireless device, as any form of television client device (e.g., television set-top box, digital video recorder (DVR), etc.), consumer device, computer device, server device, portable computer device, user device, communication device, video processing and/or rendering device, appliance device, gaming device, electronic device, and/or as any other type of device. Device 400 may also be associated with a user (i.e., a person) and/or an entity that operates the device such that a device describes logical devices that include users, software, firmware, and/or a combination of devices.

Device 400 includes communication devices 402 that enable wired and/or wireless communication of device data 404 (e.g., received data, data that is being received, data scheduled for broadcast, data packets of the data, etc.). The device data 404 or other device content can include configuration settings of the device, media content stored on the device, and/or information associated with a user of the device. Media content stored on device 400 can include any type of audio, video, and/or image data. Device 400 includes one or more data inputs 406 via which any type of data, media content, and/or inputs can be received, such as user-selectable inputs, messages, music, television media content, recorded video content, and any other type of audio, video, and/or image data received from any content and/or data source.

Device 400 also includes communication interfaces 408 that can be implemented as any one or more of a serial and/or parallel interface, a wireless interface, any type of network interface, a modem, and as any other type of communication interface. The communication interfaces 408 provide a connection and/or communication links between device 400 and a communication network by which other electronic, computing, and communication devices communicate data with device 400.

Device 400 includes one or more processors 410 (e.g., any of microprocessors, controllers, and the like) which process various computer-executable instructions to control the operation of device 400 and to implement embodiments of an interactive media social game. Alternatively or in addition, device 400 can be implemented with any one or combination of hardware, firmware, or fixed logic circuitry that is implemented in connection with processing and control circuits which are generally identified at 412. Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 400 also includes computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 400 can also include a mass storage media device 416.

Computer-readable media 414 provides data storage mechanisms to store the device data 404, as well as various device applications 418 and any other types of information and/or data related to operational aspects of device 400. For example, an operating system 420 can be maintained as a computer application with the computer-readable media 414 and executed on processors 410. The device applications 418 can include a device manager (e.g., a control application, software application, signal processing and control module, code that is native to a particular device, a hardware abstraction layer for a particular device, etc.). The device applications 418 also include any system components or modules to implement embodiments of an interactive media social game. In this example, the device applications 418 include a social game service 422 and a recommendation service 424 that are shown as software modules and/or computer applications. Alternatively or in addition, the social game service 422 and the recommendation service 424 can be implemented as hardware, software, firmware, or any combination thereof.

Device 400 also includes an audio and/or video input-output system 426 that provides audio data to an audio system 428 and/or provides video data to a display system 430. The audio system 428 and/or the display system 430 can include any devices that process, display, and/or otherwise render audio, video, and image data. Video signals and audio signals can be communicated from device 400 to an audio device and/or to a display device via an RF (radio frequency) link, S-video link, composite video link, component video link, DVI (digital video interface), analog audio connection, or other similar communication link. In an embodiment, the audio system 428 and/or the display system 430 are implemented as external components to device 400. Alternatively, the audio system 428 and/or the display system 430 are implemented as integrated components of example device 400.

Although embodiments of an interactive media social game have been described in language specific to features and/or methods, it is to be understood that the subject of the appended claims is not necessarily limited to the specific features or methods described. Rather, the specific features and methods are disclosed as example implementations of an interactive media social game.

1. A computer-implemented method, comprising:
receiving media asset interaction data that identifies media assets when at least one of downloaded or played at a user device;
correlating the media assets with a social game entity that is configured to adaptively change according to one or more characteristics of the media assets; and
communicating a status of the social game entity to a user that is associated with the social game entity and the user device.

2. A computer-implemented method as recited in claim 1, wherein the media assets are musical performances and the social game entity is a music pet that adaptively changes according to the one or more characteristics of the musical performances.

3. A computer-implemented method as recited in claim 2, wherein the one or more characteristics include a genre that is associated with the musical performances, and the music pet adaptively changes to portray the genre.

4. A computer-implemented method as recited in claim 2, wherein the music pet adaptively changes at least one of behaviors, appearance, or attributes that reflect the one or more characteristics of the musical performances.

5. A computer-implemented method as recited in claim 2, wherein the music pet represents the user in a networked social group.

6. A computer-implemented method as recited in claim 2, further comprising:
compiling the media asset interaction data that is received from the user device as a media asset selection history corresponding to the user;
determining the one or more characteristics of the media assets based on the media asset selection history; and
generating a media asset recommendation for the user based on the media asset selection history, the media asset recommendation configured as a recommendation message from the music pet to the user that is associated with the user device.

7. A computer-implemented method as recited in claim 1, further comprising receiving a user selection to initiate the social game entity that is associated with the user and the media assets that are downloaded or played at the user device.

8. A computer-implemented method as recited in claim 1, further comprising providing a reward for the user based on adaptive changes to the social game entity that are derived from the media assets that are downloaded or played at the user device.

9. A computer-implemented method as recited in claim 8, further comprising establishing a status ranking of the user based on a culmination of the adaptive changes to the social game entity.

10. A computer-implemented method as recited in claim 1, wherein the status of the social game entity is communicated to the user via the user device as at least one of a text message, an email, a data feed, or a message displayed on a user interface.

11. A computer-implemented method as recited in claim 1, wherein the social game entity represents a personality of the user as a user profile in a networked social group, and wherein the social game entity is configured for display to represent the user profile as at least one of an animation, an image, a graphic, or text.

12. A system, comprising:
at least a memory and a processor that implement a social game service configured to administrate a networked social game based on media asset interactions, the social game service further configured to:
receive media asset interaction data that identifies media assets when at least one of downloaded or played at a user device;
correlate the media assets with a music pet that is a token entity of the networked social game, the music pet configured to adaptively change according to one or more characteristics of the media assets; and
initiate a display of the music pet that represents a user associated with the user device, the user represented by the music pet in a social group of participants in the networked social game.

13. A system as recited in claim 12, wherein the music pet represents a personality of the user in the networked social game, and wherein the music pet is configured for display as at least one of an animation, an image, a graphic, or text.

14. A system as recited in claim 12, wherein the media assets are musical performances and the one or more characteristics include a genre of the musical performances, the music pet further configured to adaptively change to portray the genre.

15. A system as recited in claim 14, wherein the music pet adaptively changes at least one of behaviors, appearance, or attributes that reflect the one or more characteristics of the musical performances.

16. A system as recited in claim 12, further comprising a recommendation service configured to:
compile the media asset interaction data that is received from the user device as a media asset selection history corresponding to the user;
generate a media asset recommendation for the user based on the media asset selection history, the media asset recommendation configured as a recommendation message from the music pet to the user that is associated with the user device; and
the social game service further configured to determine the one or more characteristics of the media assets based on the media asset selection history.

17. A system as recited in claim 12, wherein the social game service is further configured to:
generate a reward for the user based on adaptive changes to the music pet that are derived from the media assets that are downloaded or played at the user device; and
establish a status ranking of the user based on a culmination of the adaptive changes to the music pet.

18. Computer-readable media having stored thereon computer-executable instructions that, when executed by a server device, initiate the server device to:
receive media asset interaction data that identifies media assets when at least one of downloaded or played at a user device;
compile the media asset interaction data as a media asset selection history corresponding to a user that is associated with the user device;
correlate the media assets with a social game entity that is configured to adaptively change according to one or more characteristics of the media assets; and
generate a media asset recommendation for the user based on the media asset selection history, the media asset recommendation configured as a recommendation message from the social game entity to the user that is associated with the user device.

19. Computer-readable media as recited in claim 18, wherein the media assets are musical performances and the social game entity is a music pet that adaptively changes at least one of behaviors, appearance, or attributes according to the one or more characteristics of the musical performances.

20. Computer-readable media as recited in claim 19, wherein the music pet represents the user in a social group of participants in a networked social game that is based on media asset interactions, and wherein the music pet is configured for display as at least one of an animation, an image, a graphic, or text on a user interface for the networked social game.
